(19) United States
(12) Patent Application Publication
(10) Pub. No.: US 2004/0263858 A1
(43) Pub. Date: Dec. 30, 2004

(54) Apparatus for measuring sub-resonance of optical pickup actuator

(76) Inventors: Jong-Sup Song, Kyunggi-do (KR); Hag-Hyeon Jang, Kyunggi-do (KR); Chun-Dong Kim, Kyunggi-do (KR); Sergiy Shylo, Kyunggi-do (KR)

Correspondence Address: GOTTLIEB RACKMAN & REISMAN PC, 270 MADISON AVENUE, 8TH FLOOR, NEW YORK, NY, 100160601

(21) Appl. No.: 10/856,316

(22) Filed: May 28, 2004

(30) Foreign Application Priority Data
Jun. 24, 2003 (KR) 2003-41257

(51) Int. Cl. G01B 9/02

(52) U.S. Cl. 356/496

(57) ABSTRACT

Disclosed herein is an apparatus for measuring sub-resonance, which is capable of simultaneously measuring the fundamental frequency characteristics and displacements of an optical pickup actuator through the use of a very simple interferometer. The sub-resonance measuring apparatus of the present invention includes a laser light source, a beam splitter, and an optical detection element. The beam splitter splits light emitted from the laser light source into two light beams. The beam splitter has a reference surface that allows a part of a first beam of the two light beams to be reflected inside of the reference surface and allows the remaining part thereof to pass through the reference surface, and a diffused surface that allows a second beam of the two light beams to be dispersed thereon. The optical detection element detects both the part of the first beam reflected inside of the beam splitter and the remaining part of the first beam passed through the reference surface and then reflected from a surface to be measured.

### BACKGROUND OF THE INVENTION

1. Field of the Invention

The present invention relates, in general, to apparatuses for measuring sub-resonance, which is capable of simultaneously measuring the fundamental frequency characteristics and displacements of an optical pickup actuator through the use of a very simple interferometer and, more particularly, to an apparatus for measuring sub-resonance, which uses a single surface of a beam splitter as a reference surface, unlike a conventional Michelson interferometer or heterodyne interferometer requiring additional expensive equipment, so that the apparatus can be easily aligned, manufactured at low costs, constructed to have a high measurement speed to such an extent as to be capable of measuring the sub-resonance of an actuator in real time in an optical pickup production line, and implemented in a small size.

2. Description of the Related Art

An optical pickup is a device mounted on an optical recording/reproducing apparatus to record and reproduce information on and from an optical disk seated on a turntable, such as a Compact Disk (CD) or a Digital Versatile Disk (DVD) which is a recording medium, in a non-contact manner while moving in the radial direction of the disk. Such an optical pickup is provided with an actuator that drives an objective lens in the track and focus directions of a disk so as to form a beam spot on the required track position of the disk.

If there is an asymmetric structural problem as in the case where the optical axis of the objective lens and the drive shaft of the actuator are different, or where the focusing and tracking coils are formed asymmetrically, sub-resonance may occur in the actuator. A rotation vibration mode, such as a pitching mode and a rolling mode attributable to the sub-resonance, negatively influences the phase and displacement of the fundamental frequency characteristics during focusing and tracking operations, thus resulting in the degradation of optical signals. Moreover, in a higher-speed and higher-density optical recording/reproducing apparatus, pitching and rolling modes more seriously occur. Therefore, in order to develop an optical pickup actuator suitable for an optical recording/reproducing apparatus tending to have a higher multiple of the speed of a first generation apparatus, there is required an apparatus for measuring the sub-resonance of an optical pickup actuator, which is capable of precisely measuring fundamental frequency characteristics, the amount of phase shift, the amount of displacement, etc.

In the prior art, a precise displacement sensor generally employs a non-contact optical method used in a Michelson or heterodyne interferometer. In an interferometer, displacement information is included in the phase of light, so that the resolution for the measurement of a displacement is determined depending on at which resolution a phase can be detected. Research on a phase detection circuit has been greatly developed. In particular, a resolution of about 0.3 nm is obtained in a commercial interferometer.

FIG. 1 is a schematic diagram of a Michelson interferometer 100 used as a conventional displacement measuring apparatus.

As shown in FIG. 1, the diameter of light generated from a Helium-Neon (He—Ne) laser light source 101 is increased using a beam expander 102. This light is split into two light beams by a beam splitter 103, and the two light beams are reflected from first and second mirrors 104 and 105, respectively, and combined with each other again by the beam splitter 103. At this time, the two light beams interfere with each other to form equally-spaced interference patterns. The light beams interfering with each other are incident on an optical detector 106, which converts optical signals for the interference patterns into electrical signals.

FIG. 2 is a schematic diagram of a heterodyne interferometer 200 used as a conventional displacement measuring apparatus.

As shown in FIG. 2, the basic construction of the heterodyne interferometer 200 is very similar to that of the Michelson interferometer 100. However, the heterodyne interferometer 200 is different from the Michelson interferometer 100 in that laser light emitted from a laser light source 201 is split into two light beams using a beam splitter 202, the two light beams are converted into two beams having different polarization states and frequency components using Acoustic-Optical Modulators (AOMs), respectively, and the two beams are combined into source light. Consequently, the source light has different polarization states and different frequency components ω₁ and ω₂.

An interferometer is configured to have a construction similar to that of a Michelson interferometer using source light having two frequency components ω₁ and ω₂, the frequency variations due to the position variations (velocity variations) of a moving corner cube 205 to be measured are measured using the Doppler effect, and the amount of displacement of the corner cube 205 is obtained.

Source light having two frequency components generated from the laser light source 201 is split by a beam splitter 202. A part of the split light passes through a polarizer 206, is transmitted to a signal transmitting unit 210 through an optical detector 208, and then used as a reference signal The remaining part of the split light is split by the polarizing beam splitter 203 into a first signal A cosω₁t+βcosω₂t and a second signal B cosω₂t+αcosω₁t having frequency components ω₁ and ω₂, respectively, depending on polarization states. The first signal is reflected from a corner cube 204 in a stop state, and the second signal is reflected from the moving corner cube 205, the displacement and frequency-phase shift of which are to be measured. The frequency component of a light beam reflected from the corner cube 205 to be measured is varied by the Doppler effect. A signal Im, including the two reflected light beams, is transmitted to the signal processing unit 210 through a polarizer 207 and an optical detector 209.

The signal processing unit 210 analyzes the reference signal Ir and the signal Im to be measured, and calculates the movement velocity, displacement and frequency-phase shift of the corner cube to be measured on the basis of the frequency component variations occurring due to the Doppler effect.

In order to function as the signal processing unit 210, a laser vibrometer employing a heterodyne interferometer uses an expensive Fast Fourier Transfer (FFT) device, which is a frequency conversion device, so as to measure the frequency characteristics of an optical pickup actuator. The heterodyne interferometer 200 is generally used for most commercial laser displacement sensors, because an optical system thereof can be easily aligned and a Signal-to-Noise Ratio (SNR) is high, unlike the Michelson interferometer 100. However, as described above, there is a disadvantage in that the heterodyne interferometer 200 is very expensive due to additional equipment.

### SUMMARY OF THE INVENTION

Accordingly, the present invention has been made keeping in mind the above problems occurring in the prior art, and an object of the present invention is to provide an apparatus for measuring sub-resonance, which uses a single surface of a beam splitter as a reference surface, unlike a conventional Michelson interferometer or heterodyne interferometer requiring additional expensive equipment, so that the apparatus can be easily aligned, manufactured at low costs, constructed to have a high measurement speed to such an extent that the sub-resonance of an actuator can be measured in real time in an optical pickup production line, and implemented with a small-sized device.

In order to accomplish the above object, the present invention provides an apparatus for measuring sub-resonance, comprising a laser light source; a beam splitter splitting light emitted from the laser light source into two light beams, the beam splitter having a reference surface that allows a part of a first beam of the two light beams to be reflected inside of the reference surface and allows the remaining part thereof to pass through the reference surface, and a diffused surface that allows a second beam of the two light beams to be dispersed thereon; and an optical detection element detecting both the part of the first beam reflected inside of the beam splitter and the remaining part of the first beam passed through the reference surface and then reflected from a surface to be measured.

Further, the present invention provides an apparatus for measuring sub-resonance of an optical pickup actuator, comprising a laser light source; a beam splitter splitting light emitted from the laser light source into two light beams, the beam splitter having a reference surface that allows a part of a first beam of the two light beams to be reflected inside of the reference surface and allows a remaining part thereof to pass through the reference surface, and a diffused surface that allows a second beam of the two light beams to be dispersed thereon; an optical pickup actuator moving an optical pickup in track and focus directions; an objective lens mounted on a support of the actuator to partially reflect the remaining part of the first beam passed through the reference surface; an optical detection element detecting the part of the first beam reflected inside of the reference surface of the beam splitter and the remaining part of the first beam partially reflected from the objective lens; and a signal processing unit generating a reference frequency and providing the reference frequency to the actuator, the signal processing unit receiving the part of the first beam, reflected inside of the beam splitter, and the remaining part of the first beam, partially reflected from the objective lens, from the optical detection element, and comparing the received beams with each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram of a Michelson interferometer used as a conventional displacement measuring apparatus;

FIG. 2 is a schematic diagram of a heterodyne interferometer used as a conventional displacement measuring apparatus;

FIG. 3a is a schematic configuration diagram of a sub-resonance measuring apparatus capable of simultaneously measuring fundamental frequency characteristics and displacement of an optical pickup actuator according to the present invention, and FIG. 3b is a view showing a cubic beam splitter having a diffused surface as a single surface according to the present invention;

FIGS. 4a and 4b are views showing the principles of the formation of interference patterns due to interference;

FIG. 5 is a schematic diagram of an apparatus implemented to measure the frequency characteristics of an actual optical pickup actuator using the apparatus of measuring sub-resonance of an optical pickup actuator according to the present invention; and

FIG. 6 is a waveform diagram showing interference pattern variation signals measured with respect to an optical pickup actuator causing actual sub-resonance through the use of a sub-resonance measuring sensor for an optical pickup actuator of the present invention.

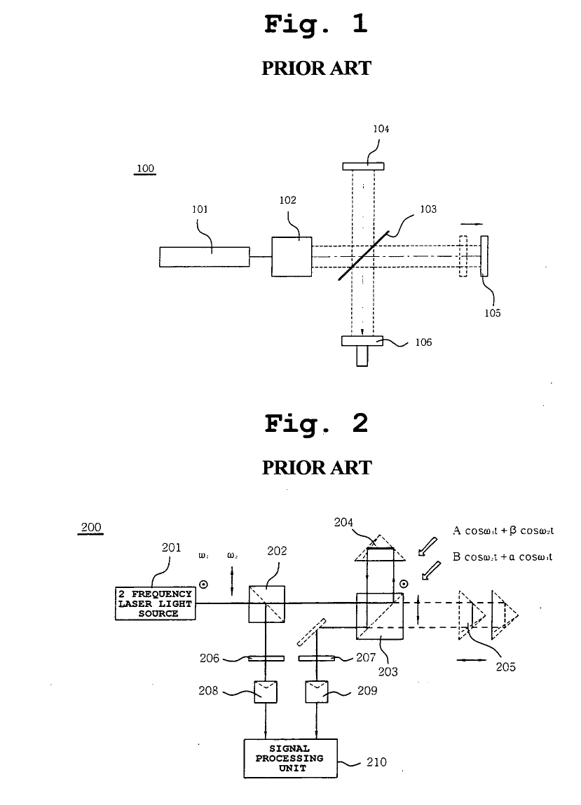

### DESCRIPTION OF THE PREFERRED EMBODIMENTS

Hereinafter, embodiments of the present invention will be described in detail with reference to the attached drawings.

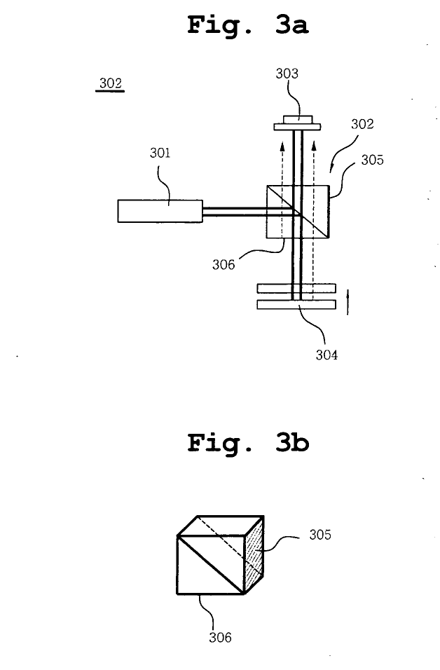

FIG. 3a is a schematic configuration diagram of a sub-resonance measuring apparatus capable of simultaneously measuring fundamental frequency characteristics and displacement of an optical pickup actuator according to the present invention, and FIG. 3b is a view showing a cubic beam splitter employed in the sub-resonance measuring apparatus of the present invention. As shown in FIG. 3b, the sub-resonance measuring apparatus is implemented with a simple interferometer using a cubic beam splitter 302 having a single surface processed to be a diffused surface. The diffused surface is formed by performing abrasive machining with respect to one surface of the cubic beam splitter 302.

Since laser light emitted from a laser light source 301 is parallel light, laser light with a diameter of approximately 0.5 to 1.5 mm can be directly used to detect interference patterns without being passed through a beam expander. The light emitted from the laser light source 301 is first split into two light beams by the beam splitter 302. One of the two light beams is directed to a diffused surface 305 and the other thereof is directed to a bottom reference surface 306. The light beam directed to the diffused surface 305 is dispersed on the surface 305, and a part of the light beam directed to the reference surface 306 is reflected inside of the reference surface 306 and the remaining part thereof passes through the reference surface 306.

In the cubic beam splitter 302 of the present invention, the surface 305, on which light will be dispersed, is processed through a method, such as abrasive machining, thus preventing light from being reflected therefrom or passing therethrough.

A light beam R₁ reflected inside of the reference surface 306 of the beam splitter 302 is transmitted to the optical detector 303 after passing through the beam splitter 302. A reference light beam is set to this reflected light beam R₁. The light beam passed through the beam splitter 302 is directed to a surface 304 to be measured. A light beam R₂ reflected from the measurement surface 304 passes through the beam splitter 302 and is then directed to the optical detector 303. Therefore, the light beam R₁ reflected inside of the beam splitter 302 and the light beam R₂ reflected from the measurement surface 304 interfere with each other.

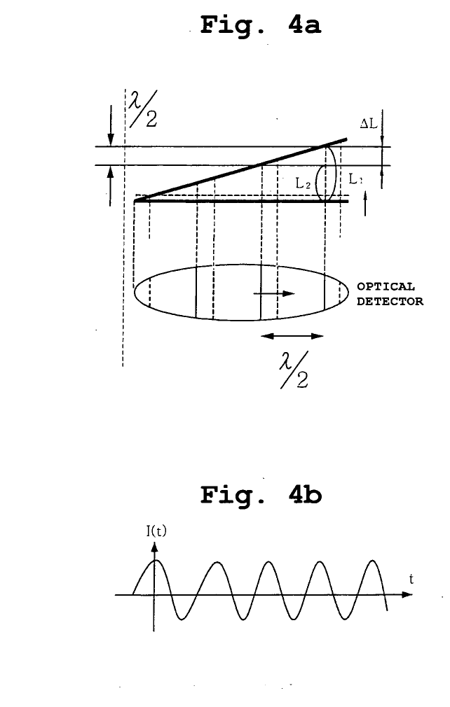

With reference to FIGS. 4a and 4b, the principles of generating interference patterns due to interference are described.

In FIG. 4a, interference patterns are formed by a difference between the paths of the light beams reflected from two different mirrors or the reflection surfaces thereof. That is, the interference patterns are formed at locations where the path difference corresponds to a value integer times a half of the wavelength of the laser light beam, that is, ΔL=λ·n/2 (where ΔL is the difference between the paths of laser light beams reflected from two different mirrors at specific locations, that is, ΔL=L₁−L₂, λ is the wavelength of laser light beam, and n is an integer). If two mirrors are parallel, the interference patterns may have infinite intervals therebetween, and the entire areas of the interference patterns become bright or dark. Therefore, if the variation ΔL of the interference patterns is measured, the relative displacement of a mirror to be measured can be obtained.

FIG. 4b illustrates the intensity I(t) of the interference patterns according to time, in which the brightness of the interference patterns is maximized at a time when the amplitude of a sine wave is maximum, and the brightness thereof is minimized at a time when the amplitude of the sine wave is minimum.

Referring to FIG. 3a again, the interference patterns are formed whenever the difference between the optical paths of the reference light beam R₁ reflected inside of the beam splitter 302 and the light beam R₂ reflected from the measurement surface 304 becomes a value integer times a half of the wavelength λ of the laser light beam. If the measurement surface 304 is tilted slightly relative to the reference surface, the reference light beam R₁ reflected inside of the beam splitter 302 and the light beam R₂ reflected from the measurement surface 304 interfere with each other to form equally-spaced interference patterns. Such an interval between the interference patterns can be determined by a tilt angle between two optical wavefronts. If a displacement occurs on the measurement surface after the equally-spaced interference patterns are formed, the interference patterns move from locations represented by solid lines on the optical detector to locations represented by dotted lines in FIG. 4a.

The movement direction of the interference patterns varies with the displacement direction of the measurement surface 304. If the measurement surface 304 regularly varies, the intensity variations of the signals due to the variations of the interference patterns of FIG. 4b can be obtained.

If the measurement surface 304 vibrates, the variations of the interference patterns, the number of which is equal to the number of vibrations, occur. If the variations of the interference patterns are obtained through the above-described method, the oscillation frequency of the measurement surface 304 can be measured on the basis of the variations. If sub-resonance occurs in the optical pickup actuator in a certain frequency region, the amplitude of the vibration of the actuator is increased in the certain frequency region, and the shift of a phase arises. Therefore, the sub-resonance of the optical pickup actuator can be directly measured on the basis of the variations of the interference patterns.

A sensor for measuring this sub-resonance is advantageous in that it can be more easily aligned and manufactured to have a small size, because it uses one surface of the beam splitter 302 as a reference surface, unlike the conventional Michelson interferometer 100 or the heterodyne interferometer 200 requiring additional expensive equipment with high precision.

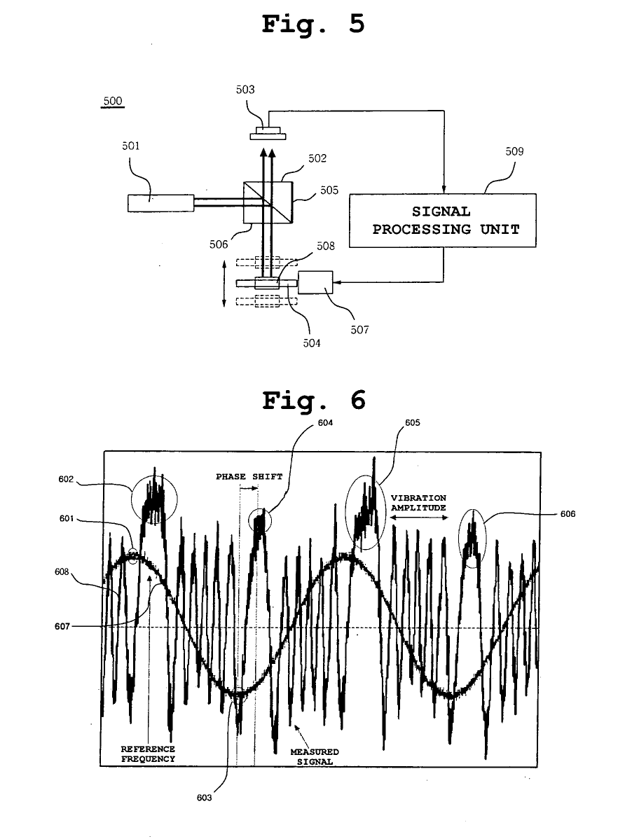

FIG. 5 is a schematic diagram of an apparatus implemented to measure the frequency characteristics of an actual optical pickup actuator using the sub-resonance measuring apparatus for the optical pickup actuator of the present invention.

Laser light emitted from a He—Ne laser light source 501 is split into two equal light beams by a beam splitter 502. One of the two light beams is dispersed by a diffused surface 505. A part (4%) of the other of the two light beams is reflected from a reference surface 506 of the beam splitter 502, and the remaining 96% thereof passes through the reference surface 506 and is then reflected from an objective lens 508 mounted on a support 504 of an actuator 507.

A part of the light beam reflected inside of the reference surface 506 of the beam splitter 502 passes through the beam splitter 502 and is directed to the optical detector 503. A part (1%) of the light beam, passed through the beam splitter 502, is reflected from the objective lens 508 mounted on the support 504, partially passes through the beam splitter 502 and is then directed to the optical detector 503. Therefore, the light beam, reflected inside of the reference surface 506 of the beam splitter 502, and the light beam, reflected from the objective lens 508 of the optical pickup actuator 507, interfere with each other. In this case, for the light beam reflected from the objective lens 508, a light beam reflected from the plane of the edge of the objective lens 508, not the lens body of the objective lens 508 having a curvature, is used. The edge of the objective lens 508, generally used for optical pickups, is processed to be a plane, thus obtaining a reflected light beam of about 1% from this optical plane. The optical detector 503 converts the detected light beam into an electrical signal and then transmits the electrical signal to a signal processing unit 509.

If the signal processing unit 509 applies an oscillation frequency to the optical pickup actuator 507, the optical detector 503 obtains signals due to the variations of interference patterns. The signal processing unit 509 compares the frequency applied to the optical pickup actuator 507 and a frequency obtained through the optical detector 503, and then measures the frequency characteristics, the phase shift and the amount of displacement of the optical pickup actuator 507. Therefore, the phase shift due to the sub-resonance of the optical pickup actuator 507 can be easily measured through the use of the apparatus of the present invention.

FIG. 6 is a waveform diagram showing interference pattern variation signals measured with respect to an optical pickup actuator causing actual sub-resonance through the use of the sub-resonance measuring apparatus for an optical pickup actuator of the present invention. A first signal 607 represents a signal with the frequency applied to the optical pickup actuator and a second signal 608 represents a reaction signal of the optical pickup actuator 507 measured by directly exploiting the measuring apparatus of the present invention. That is, the first signal 607 is a reference signal for measurements, and the second signal 608 is a signal varied with the reaction of the optical pickup actuator 507 to be measured. On the basis of the results of the measurements, the existence of a phase shift due to the sub-resonance in the optical pickup actuator 507 can be easily ascertained and a quantitative analysis can be performed.

As shown in FIG. 6, the first signal 607 with the reference frequency, which is a known value, is compared with the second signal 608, so that the characteristics of the frequency of the second signal 608, that is, the oscillation frequency of the actuator 507 to be measured, can be measured.

In FIG. 6, if the second signal 608 measured by the reaction of the actuator 507 is taken into consideration, a regular periodicity can be detected. In detail, the measured second signal 608 is comprised of signals 602, 604, 605 and 606 having longer periods, and signals having shorter periods located therebetween. In this case, the signals 602, 604, 605 and 606 having longer periods represent turning points appearing when the actuator performs a periodic movement, that is, times when the vibrating actuator 507 changes a movement direction. Further, the signals having shorter periods represent amplitudes at which the vibrating actuator 507 moves. In the case of the signals 602, 604, 605 and 606 having longer periods, the signals 602 and 605 corresponding to odd-numbered periods and the signals 604 and 606 corresponding to even-numbered periods have similar patterns. Further, in the case of the signals having shorter periods, signals, the number of which is uniform, are interposed between the signals 602, 604, 605 and 606 having longer periods.

As shown in FIG. 6, a phase shift can be obtained using a difference between a position corresponding to the maximum value 601 or minimum value 603 of the first signal 607 on the basis of a central horizontal axis and the middle position of each of the signals 602, 604, 605 and 606 having longer periods of the second signal 608.

Further, the vibration amplitude of the optical pickup actuator 507 can be additionally obtained using the number of interference patterns. The maximum values 602, 604, 605 and 606 of the second signal 608 correspond to the points where the vibrating actuator moves and changes its direction, that is, turning points. The number of peak values (in this case, five) of the signals having shorter periods, exiting between the maximum values 602, 604, 605 and 606), corresponds to the vibration displacement of the actuator, that is, a vibration width. In the case of FIG. 6, since five peak values exist between the maximum values of the second signal 602, 604, 605 and 606, the vibration amplitude A of the actuator is equal to A=λ/2×5, where λ is the wavelength of a laser light beam.

As described above, the present invention provides an apparatus for measuring sub-resonance, which uses a single surface of a beam splitter as a reference surface, unlike a conventional Michelson interferometer or heterodyne interferometer requiring additional expensive equipment, so that the apparatus can be easily aligned, manufactured at low costs, constructed to have a high measurement speed to such an extent that the sub-resonance of an actuator can be measured in real time in an optical pickup production line, and implemented with a small-sized device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for measuring sub-resonance, comprising:
a laser light source;
a beam splitter splitting light emitted from the laser light source into two light beams, the beam splitter having a reference surface that allows a part of a first beam of the two light beams to be reflected inside of the reference surface and allows the remaining part thereof to pass through the reference surface, and a diffused surface that allows a second beam of the two light beams to be dispersed thereon; and
an optical detection element detecting both the part of the first beam reflected inside of the beam splitter and the remaining part of the first beam passed through the reference surface and then reflected from a surface to be measured.

2. The sub-resonance measuring apparatus according to claim 1, wherein the diffused surface is formed through abrasive machining.

3. The sub-resonance measuring apparatus according to claim 1, wherein the beam splitter is a cubic beam splitter.

4. The sub-resonance measuring apparatus according to claim 1, wherein the laser light source is a He—Ne laser light source.

5. The sub-resonance measuring apparatus according to claim 4, wherein the laser light source emits laser light having a diameter of 0.5 to 1.5 mm, without aid of a beam expander.

6. The sub-resonance measuring apparatus according to claim 1, wherein the reference surface has an optical reflexibility of 4% and an optical transmissivity of 99%.

7. An apparatus for measuring sub-resonance of an optical pickup actuator, comprising:
a laser light source;
a beam splitter splitting light emitted from the laser light source into two light beams, the beam splitter having a reference surface that allows a part of a first beam of the two light beams to be reflected inside of the reference surface and allows a remaining part thereof to pass through the reference surface, and a diffused surface that allows a second beam of the two light beams to be dispersed thereon;
an optical pickup actuator moving an optical pickup in track and focus directions;
an objective lens mounted on a support of the actuator to partially reflect the remaining part of the first beam passed through the reference surface;
an optical detection element detecting the part of the first beam reflected inside of the reference surface of the beam splitter and the remaining part of the first beam partially reflected from the objective lens; and
a signal processing unit generating a reference frequency and providing the reference frequency to the actuator, the signal processing unit receiving the part of the first beam, reflected inside of the beam splitter, and the remaining part of the first beam, partially reflected from the objective lens, from the optical detection element, and comparing the received beams with each other.

8. The sub-resonance measuring apparatus according to claim 7, wherein the diffused surface is formed through abrasive machining.

9. The sub-resonance measuring apparatus according to claim 7, wherein the beam splitter is a cubic beam splitter.

10. The sub-resonance measuring apparatus according to claim 7, wherein the laser light source is a He—Ne laser light source.

11. The sub-resonance measuring apparatus according to claim 10, wherein the laser light source emits laser light having a diameter of 0.5 to 1.5 mm, without aid of a beam expander.

12. The sub-resonance measuring apparatus according to claim 7, wherein the reference surface has an optical reflexibility of 4% and an optical transmissivity of 99%.
